(19) United States
(12) Patent Application Publication
(10) Pub. No.: US 2010/0008348 A1
(43) Pub. Date: Jan. 14, 2010

(54) UPLINK TTI BUNDLING WITH MEASUREMENT GAPS

(75) Inventors: Guodong Zhang, Syosset, NY (US); Jin Wang, Central Islip, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/499,178

(22) Filed: Jul. 8, 2009

Related U.S. Application Data
(60) Provisional application No. 61/079,611, filed on Jul. 10, 2008.

(51) Int. Cl. H04J 3/00

(52) U.S. Cl. 370/345

(57) ABSTRACT

A method and apparatus for wireless transmit receive unit (WTRU) to transmit a time transmission interval (TTI) bundle. The TTI bundle conflicts with a measurement gap, and the WTRU is configured to construct TTI bundle comprising a plurality of sub-frames, determine at least one of the plurality of sub-frames is in conflict with a measurement gap, determine a first of the plurality of sub-frames not in conflict with the measurement gap, associate the first of the plurality of sub-frames not in conflict with the measurement gap with a first redundancy version (RV), and transmit the first of the plurality of sub-frames in association with the first RV.

### CROSS REFERENCE TO RELATED APPLICATIONS

This application claims the benefit of U.S. Provisional Application No. 61/079,611 filed on Jul. 10, 2008, which is incorporated by reference as if fully set forth.

### TECHNICAL FIELD

This application is related to wireless communications.

### BACKGROUND

In Third Generation Partnership Project (3GPP) Long Term Evolution (LTE) wireless communication systems, transmission time interval (TTI) bundling is used in uplink (UL) communication to improve coverage for wireless transmit/receive units (WTRUs) near an edge of a cell. For LTE frequency division duplex (FDD) systems, a hybrid automatic repeat request (HARQ) process and the redundancy versions (RV) associated with the HARQ process are bundled and transmitted in a fixed number of consecutive TTIs, such as four (4), for example.

FIG. 1 shows a method of uplink TTI bundling 100 in accordance with the prior art. The HARQ RTT time 102 is the minimum number of sub-frames before a downlink (DL) HARQ retransmission is expected by the WTRU. As shown in FIG. 1, data 110 is transmitted in sub-frame 1 (102), sub-frame 2 (104), sub-frame 3 (106) and sub-frame 4 (108). A negative acknowledge signal (NACK) 112 for sub-frame 4 (108) is received by the WTRU in sub-frame 8 (114). The WTRU then retransmits sub-frame 4 (108), the sub-frame that was NACKed, in four (4) sub-frames (116 through 122) after the RTT time 102.

When a WTRU is in connected mode, it uses measurement gaps to stop active communication and take measurements of neighboring cells for possible handover. The measurement gaps are scheduled by an eNodeB (eNB). The eNB may schedule the measurement gap without consideration for the possibility that the WTRU may need to retransmit sub-frames as part of a HARQ process. Therefore, the eNB may schedule a measurement gap for the WTRU at the same time the WTRU is retransmitting due to a NACK. If that occurs, the TTI bundle may overlap with the measurement gap, and the WTRU may be required to perform two mutually exclusive processes. FIG. 2 shows a measurement gap overlapping with a TTI bundle 200 in accordance with the prior art. The measurement gap 202 overlaps sub-frame 1 (204) of the TTI bundle 206. As the WTRU cannot perform HARQ retransmission and measurements at the same time, only a fraction of the TTI bundle 206 may be transmitted.

### SUMMARY

A method and apparatus is disclosed for a wireless transmit receive unit (WTRU) to transmit a time transmission interval (TTI) bundle that conflicts with a measurement gap. The WTRU may construct the TTI bundle that includes multiple sub-frames, determine that at least one sub-frame is in conflict with the measurement gap, and determine that at least one sub-frame is not in conflict with the measurement gap. The WTRU may then associate the first non-conflicted sub-frame with a first redundancy version (RV), the second non-conflicted sub-frame, if available, with a second RV and, the third non-conflicted sub-frame, if available, with a third RV. The non-conflicted sub-frames are transmitted, and the conflicted sub-frames are not transmitted.

### BRIEF DESCRIPTION OF THE DRAWINGS

A more detailed understanding may be had from the following description, given by way of example in conjunction with the accompanying drawings wherein:

FIG. 1 shows a method of uplink TTI bundling in accordance with the prior art.

FIG. 2 shows a measurement gap overlapping with a TTI bundle in accordance with the prior art;

FIG. 3 shows a wireless communication system including a plurality of WTRUs and an e Node B (eNB);

FIG. 4 is a functional block diagram of the WTRU and the eNB of the wireless communication system of FIG. 3;

FIG. 5 shows a TTI bundle in accordance with one embodiment;

FIG. 6 shows a method of transmitting a TTI bundle with a first overlapped sub-frame in accordance with one embodiment;

FIG. 7 shows the method of transmitting a TTI bundle with a last overlapped sub-frame in accordance with one embodiment;

FIG. 8 shows the method for transmitting a TTI bundle with the first two sub-frames overlapped in accordance with one embodiment;

FIG. 9 shows the method for transmitting the TTI bundle with the last two sub-frames overlapped in accordance with one embodiment;

FIG. 10 shows the method for transmitting the TTI bundle with the first three sub-frames overlapped in accordance with one embodiment; and

FIG. 11 shows the method for transmitting the TTI bundle with the last three sub-frames overlapped in accordance with one embodiment.

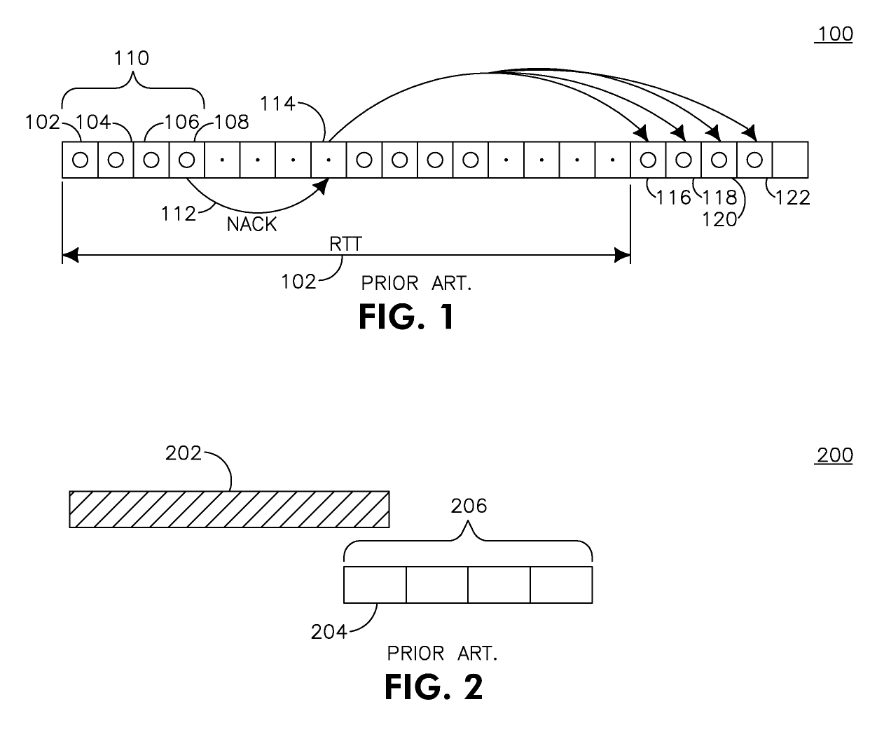

### DETAILED DESCRIPTION

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to herein, the terminology “base station” includes but is not limited to a Node-B, a site controller, an access point (AP), or any other type of interfacing device capable of operating in a wireless environment.

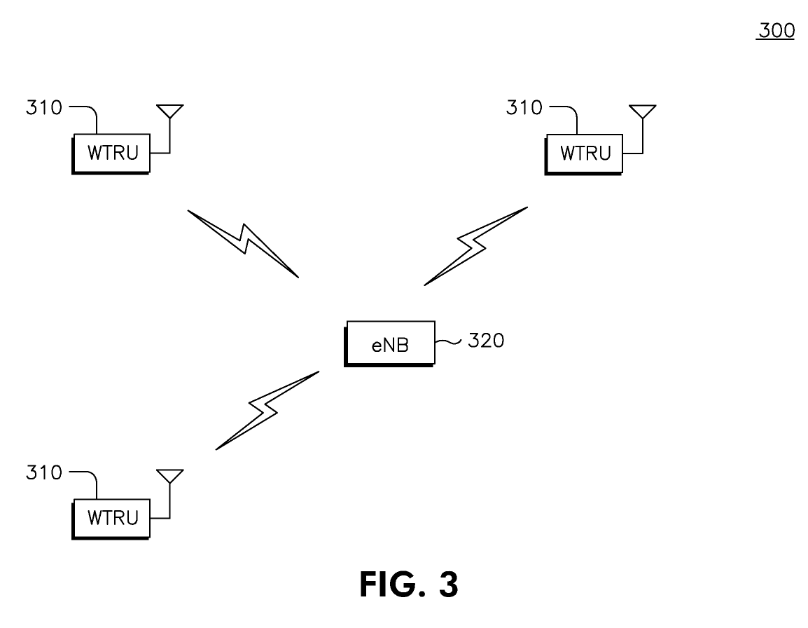

FIG. 3 shows a wireless communication system 300 including a plurality of WTRUs 310 and an e Node B (eNB) 320. As shown in FIG. 3, the WTRUs 310 are in communication with the eNB 320. Although three WTRUs 310 and one eNB 320 are shown in FIG. 3, it should be noted that any combination of wireless and wired devices may be included in the wireless communication system 300.

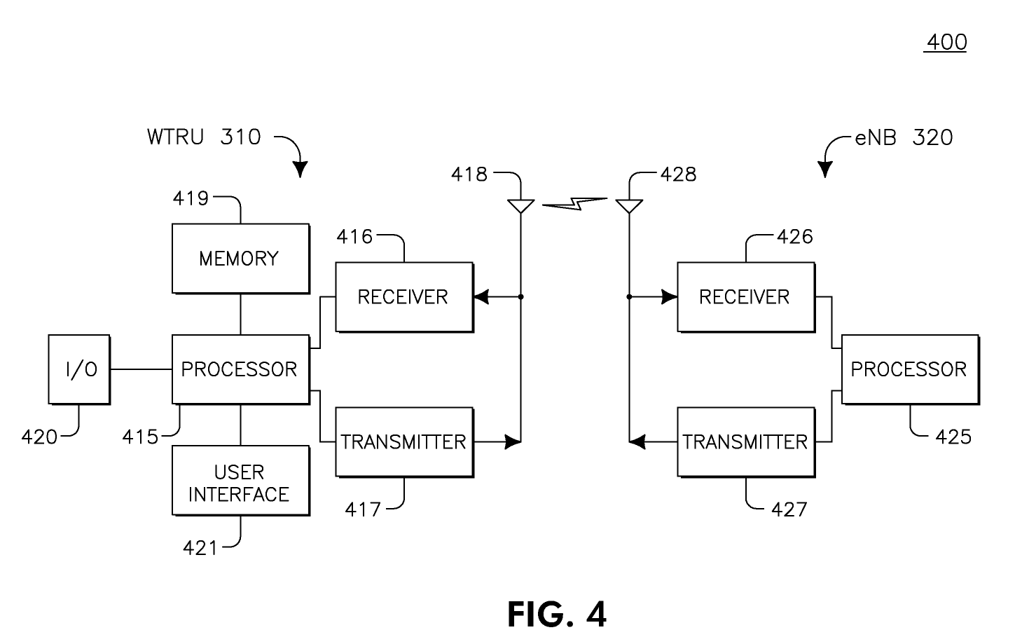

FIG. 4 is a functional block diagram 400 of a WTRU 310 and the eNB 320 of the wireless communication system 300 of FIG. 3. As shown in FIG. 3, the WTRU 310 is in communication with the eNB 320. The WTRU 310 is configured to perform measurements as required. If the WTRU 310 is in connected mode, the WTRU 310 is configured to perform the measurement routines during a measurement gap. The WTRU 310 is also configured to transmit signals in sub-frames grouped into TTI bundles.

In addition to the components that may be found in a typical WTRU, the WTRU 310 includes a processor 415, a receiver 416, a transmitter 417, and an antenna 418. The WTRU 310 may also include a user interface 421, which may include, but is not limited to, an LCD or LED screen, a touch screen, a keyboard, a stylus, or any other typical input/output device. The WTRU 310 may also include memory 419, both volatile and non-volatile as well as interfaces 420 to other WTRU's, such as USB ports, serial ports and the like. The receiver 416 and the transmitter 417 are in communication with the processor 415. The antenna 418 is in communication with both the receiver 416 and the transmitter 417 to facilitate the transmission and reception of wireless data.

In addition to the components that may be found in a typical eNB, the eNB 320 includes a processor 425, a receiver 426, a transmitter 427, and an antenna 428. The receiver 426 and the transmitter 427 are in communication with the processor 425. The antenna 428 is in communication with both the receiver 426 and the transmitter 427 to facilitate the transmission and reception of wireless data.

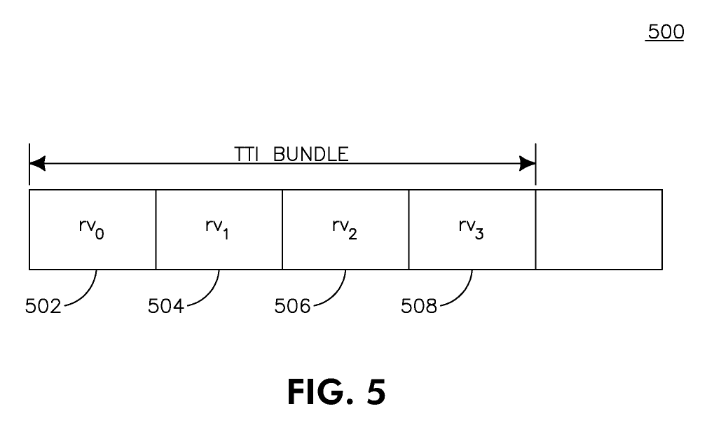

FIG. 5 shows a TTI bundle 500 in accordance with one embodiment. Within one TTI bundle 500 transmission, the same data is transmitted over 4 consecutive sub-frames using, or associated with, different redundancy versions (RV).

An RV specifies a starting point in a circular buffer to start reading out bits. Different RV's are specified by defining different starting points to enable HARQ operation. RV0 may be selected for the first transmission, as this allows the transmission of as many systematic bits as possible. Different RVs may be selected for retransmission of the same packet to support various types of HARQ combining. Several RV sequences may be used for TTI bundling. For example, a sequence of RV0, RV2, RV3, and RV1 may be used. By way of another example, a sequence of RV0, RV1, RV2, and RV3 may be used. In general, any sequence starting with RV0 may be used, as RV0 includes the most systematic bits. As used herein, RVᵢ with i=1, 2, 3 or 4, is an index and may reference any RV. For example, RV₁ may refer to RV3.

Turning back to FIG. 5, the first sub-frame 502 includes data associated with RV₀. RV₀ includes most systematic bits. The second sub-frame 504 includes data associated with RV₁. The third sub-frame 506 includes data associated with RV₂ and the third sub-frame 508 includes data associated with RV₃. When at least part of the TTI bundle 500 overlaps with a measurement gap, the portion of the TTI bundle 500 that overlaps with the measurement gap will not be transmitted. The non-overlapping portion of the TTI bundle 500 will be transmitted.

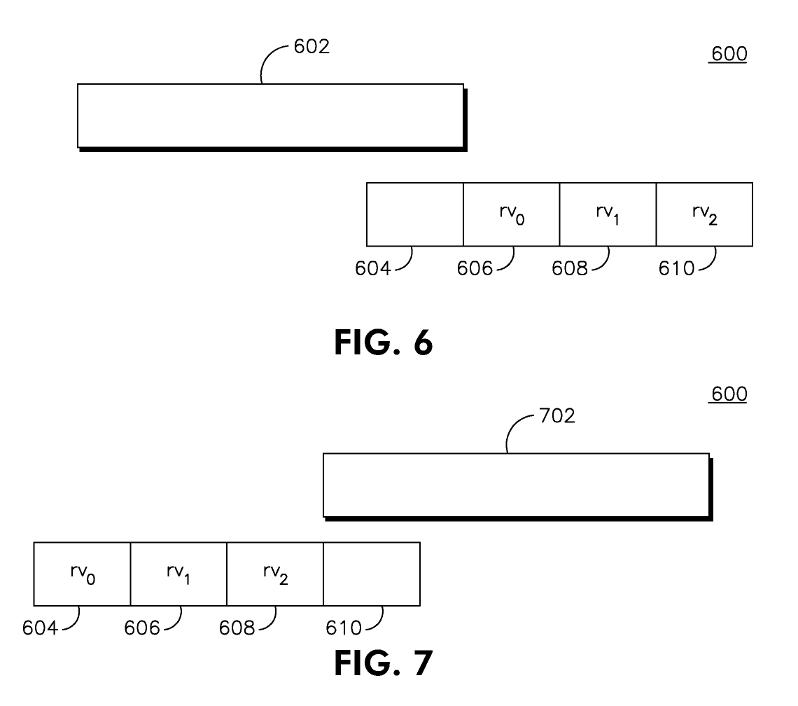

When one sub-frame overlaps with the measurement gap, the RV sequence {rv₀, rv₁, rv₂} may used for sub-frames that are not overlapped by the measurement gap. The RV sequence may be used when the first sub-frame is overlapped or the last sub-frame is overlapped. FIG. 6 shows a method of transmitting a TTI bundle 600 with a first overlapped sub-frame in accordance with one embodiment. The measurement gap 602 overlaps the first sub-frame 604. Therefore, the first overlapped sub-frame 604 is not transmitted. The second sub-frame 606 is the first transmitted sub-frame and includes data associated with RV₀. The third sub-frame 608 and the fourth sub-frame 610 are also both transmitted, and include data associated with RV₁ and RV₂, respectively.

FIG. 7 shows the method of transmitting a TTI bundle 600 with a last overlapped sub-frame in accordance with one embodiment. In FIG. 7, the measurement gap 702 overlaps the fourth sub-frame 704 of the TTI bundle. Therefore, the fourth sub-frame 704 of the TTI bundle is not transmitted. The first sub-frame 706 of the TTI bundle includes data associated with RV₀, the second sub-frame 708 of the TTI bundle includes data associated with RV₁, and the third sub-frame of the TTI bundle 710 includes data associated with RV₂. The first sub-frame 706, the second sub-frame 708 and the third sub-frame 710 are transmitted.

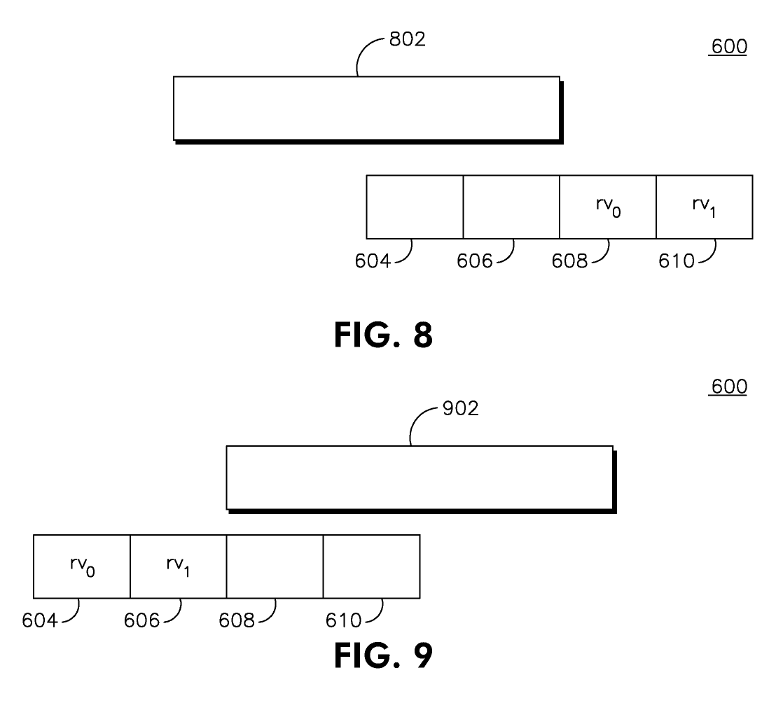

Two of the four sub-frames in a TTI bundle may overlap with the measurement gap. FIG. 8 shows the method for transmitting a TTI bundle 600 with the first two sub-frames overlapped in accordance with one embodiment. The measurement gap 802 overlaps 2 sub-frames, the first sub-frame 804 and the second sub-frame 806. The first sub-frame 804 and the second sub-frame 806 are not transmitted. The third sub-frame 808 includes data associated with RV₀ and is transmitted first. The fourth sub-frame 810 includes data associated with RV₁ and is transmitted second. The RV sequence {rv₀, rv₁} is used for TTIs that are not affected by the measurement gap.

FIG. 9 shows the method for transmitting the TTI bundle 600 with the last two sub-frames overlapped in accordance with one embodiment. The measurement gap 902 overlaps 2 sub-frames, the last sub-frame 904 and the second to last sub-frame 906. The last sub-frame 904 and the second to last sub-frame 906 are not transmitted. The first sub-frame 908 includes data associated with RV₀ and is transmitted first. The second TTI sub-frame 910 includes data associated with RV₁ and is transmitted second. The RV sequence {rv₀, rv₁} is again used for sub-frames that are not affected by the measurement gap. Alternatively, RV sequence {rv₂, rv₃} may be used when two sub-frames overlap with measurement gap.

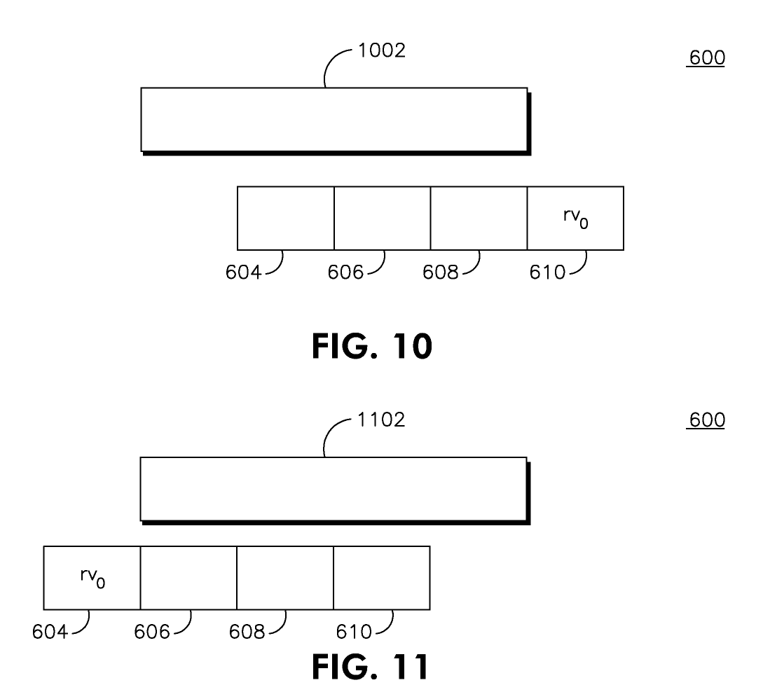

If three sub-frames overlap with the measurement gap, RV₀ may be selected for the sub-frame that is not affected by the measurement gap. FIG. 10 shows the method for transmitting the TTI bundle 600 with the first three sub-frames overlapped in accordance with one embodiment. The measurement gap 1002 overlaps three (3) sub-frames, the first sub-frame 1004, the second sub-frame 1006 and the third sub-frame 1008. These sub-frames are not transmitted. The last sub-frame 101 includes data associated with RV0 and is transmitted. The RV sequence {rv₀} is used for the TTI that is not affected by the measurement gap.

FIG. 11 shows the method for transmitting the TTI bundle 600 with the last three sub-frames overlapped in accordance with one embodiment. The measurement gap 1102 overlaps three (3) sub-frames, the second sub-frame 1106, the third sub-frame 1108 and the fourth sub-frame 1110. These sub-frames are not transmitted. The first sub-frame 1104 includes data associated with RV₀ and is transmitted. The RV sequence {rv₀} is used for the TTI that is not affected by the measurement gap

Alternatively, the TTI bundle transmission may be cancelled when part of the TTI bundle overlaps with a measurement gap. If any k, with k being an integer between 1 and 4, sub-frames of the TTI bundle overlap with a measurement gap, the transmission of the TTI bundle may be cancelled.

Although the features and elements of the present invention are described in particular combinations, each feature or element can be used alone without the other features and elements of the preferred embodiments or in various combinations with or without other features and elements of the present invention.

While the present invention has been described in terms of the preferred embodiment, other variations which are within the scope of the invention will be apparent to those skilled in the art.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of a wireless transmit receive unit (WTRU) transmitting a time transmission interval (TTI) bundle, wherein a portion of the TTI bundle conflicts with a measurement gap, the method comprising:
constructing a TTI bundle comprising a plurality of sub-frames;
determining at least one of the plurality of sub-frames is in conflict with a measurement gap;
determining a first of the plurality of sub-frames not in conflict with the measurement gap;
associating the first of the plurality of sub-frames not in conflict with the measurement gap with a first redundancy version (RV); and
transmitting the first of the plurality of sub-frames in association with the first RV.

2. The method as in claim 1 further comprising:
determining a second of the plurality of sub-frames not in conflict with the measurement gap;
associating the second of the plurality of sub-frames not in conflict with the measurement gap with a second RV;
transmitting the second of the plurality of sub-frames in association with the second RV.

3. The method as in claim 2 further comprising transmitting the second of the plurality of sub-frames after the first of the plurality of sub-frames.

4. The method as in claim 1 further comprising preventing transmission of the at least one of the plurality of sub-frames in conflict with the measurement gap.

5. The method as in claim 1 further comprising:
determining that a first two sub-frames are is in conflict with the measurement gap;
preventing transmission of the first two sub-frames;
associating a third sub-frame with the first redundancy version and a fourth sub-frame with a second redundancy version; and
transmitting the third sub-frame and the fourth sub-frame.

6. The method as in claim 1 further comprising:
determining that a first three sub-frames are in conflict with the measurement gap;
preventing transmission of the first three sub-frames;
associating a fourth sub-frame with the first redundancy version; and
transmitting the fourth sub-frame.

7. The method as in claim 1 further comprising:
determining that a last two sub-frames are in conflict with the measurement gap; and
preventing transmission of the last two sub-frames.

8. The method as in claim 1 further comprising:
determining that a last three sub-frames are in conflict with the measurement gap; and
preventing transmission of the last three sub-frames.

9. A method of a wireless transmit receive unit (WTRU) transmitting a time transmission interval (TTI) bundle, wherein a portion of the TTI bundle conflicts with a measurement gap, the method comprising:
constructing a TTI bundle comprising a plurality of sub-frames;
determining at least one of the plurality of sub-frames is in conflict with a measurement gap;
determining a first of the plurality of sub-frames not in conflict with the measurement gap;
associating the first of the plurality of sub-frames not in conflict with the measurement gap with a first redundancy version (RV);
determining a second of the plurality of sub-frames not in conflict with the measurement gap;
associating the second of the plurality of sub-frames not in conflict with the measurement gap with a second RV;
transmitting the first of the plurality of sub-frames in association with the first RV and the second of the plurality of sub-frames in association with the second RV; and
preventing transmission of the at least one of the plurality of sub-frames in conflict with the measurement gap.

10. A wireless transmit receive unit (WTRU) configured to transmit a time transmission interval (TTI) bundle, wherein a portion of the TTI bundle conflicts with a measurement gap, the WTRU comprising:
a processor configured to:
construct a TTI bundle comprising a plurality of sub-frames;
determine at least one of the plurality of sub-frames is in conflict with a measurement gap;
determine a first of the plurality of sub-frames not in conflict with the measurement gap; and
associate the first of the plurality of sub-frames not in conflict with the measurement gap with a first redundancy version (RV); and
a transmitter configured to transmit the first of the plurality of sub-frames in association with the first RV.

11. The WTRU as in claim 10 wherein:
the processor is further configured to:
determine a second of the plurality of sub-frames not in conflict with the measurement gap; and
associate the second of the plurality of sub-frames not in conflict with the measurement gap with a second RV; and
the transmitter is further configured to transmit the second of the plurality of sub-frames in association with the second RV.

12. The WTRU as in claim 11 wherein the transmitter is further configured to transmit the second of the plurality of sub-frames after the first of the plurality of sub-frames.

13. The WTRU as in claim 1 wherein the processor is further configured to prevent transmission of the at least one of the plurality of sub-frames in conflict with the measurement gap.

14. The WTRU as in claim 10 wherein:
the processor is further configured to:
determine that a first two sub-frames are is in conflict with the measurement gap;
prevent transmission of the first two sub-frames; and
associate a third sub-frame with the first redundancy version and a fourth sub-frame with a second redundancy version; and
the transmitter is further configured to transmit the third sub-frame and the fourth sub-frame.

15. The WTRU as in claim 10 wherein:
the processor is further configured to:
determine that a first three sub-frames are in conflict with the measurement gap;
prevent transmission of the first three sub-frames; and
associate a fourth sub-frame with the first redundancy version; and
the transmitter is further configured to transmit the fourth sub-frame.

16. The WTRU as in claim 10 wherein the processor is further configured to:
determine that a last two sub-frames are in conflict with the measurement gap; and
prevent transmission of the last two sub-frames.

17. The WTRU as in claim 10 wherein the processor is further configured to:
determine that a last three sub-frames are in conflict with the measurement gap; and
prevent transmission of the last three sub-frames.

18. A wireless transmit receive unit (WTRU) configured to transmit a time transmission interval (TTI) bundle, wherein a portion of the TTI bundle conflicts with a measurement gap, the WTRU comprising:
a processor configured to:
construct a TTI bundle comprising a plurality of sub-frames;
determine at least one of the plurality of sub-frames is in conflict with a measurement gap;
determine a first of the plurality of sub-frames not in conflict with the measurement gap;
associate the first of the plurality of sub-frames not in conflict with the measurement gap with a first redundancy version (RV);
determine a second of the plurality of sub-frames not in conflict with the measurement gap;
associate the second of the plurality of sub-frames not in conflict with the measurement gap with a second RV; and
prevent transmission of the at least one of the plurality of sub-frames in conflict with the measurement gap; and
a transmitter configured to transmit the first of the plurality of sub-frames in association with the first RV and the second of the plurality of sub-frames in association with the second RV.
